(19) United States
(12) Patent Application Publication
(10) Pub. No.: US 2023/0054418 A1
(43) Pub. Date: Feb. 23, 2023

(54) NOTIFICATION DEVICE AND NOTIFICATION METHOD

(71) Applicant: Nippon Telegraph and Telephone Corporation, Tokyo (JP)

(72) Inventors: Arinobu NIIJIMA, Musashino-shi, Tokyo (JP); Toki TAKEDA, Musashino-shi, Tokyo (JP); Takafumi MUKOUCHI, Musashino-shi, Tokyo (JP); Takashi SATO, Musashino-shi, Tokyo (JP)

(21) Appl. No.: 17/797,524

(22) PCT Filed: Feb. 6, 2020
(86) PCT No.: PCT/JP2020/004595

§ 371 Date: Aug. 4, 2022

(51) Int. Cl. G08B 6/00

(52) U.S. Cl. CPC G08B 6/00

(57) ABSTRACT

A notification device includes a detection section which detects occurrence of an event which a user is to be notified of, an estimation section which estimates whether or not the user is vibrating, and a stimulation presentation section which provides a notification to the user by presenting a thermal stimulation in a case where the user is vibrating and presenting a vibratory stimulation in a case where the user is not vibrating when the detection section detects the occurrence of the event.

### TECHNICAL FIELD

The present invention relates to a notification device and a notification method.

### BACKGROUND ART

With the development of electronic equipment such as a smartphone or a smartwatch, a method in which the electronic equipment presents a vibratory stimulation and a notification is thereby provided to a user is popular.

In addition, there is a system which estimates whether a user is walking, is running, or is in other states by using an acceleration sensor (PTL 1).

### CITATION LIST

### Patent Literature

[PTL 1] Japanese Patent No. 6089056

### SUMMARY OF THE INVENTION

### Technical Problem

However, in the case where the user is in motion involving vibration such as walking or running, even when the electronic equipment presents the vibratory stimulation, there are cases where it is difficult for the user to notice the vibration, and the user does not notice information notification by the electronic equipment.

The present invention has been made in view of the above circumstances, and an object of the present invention is to provide a technique which allows a notification from electronic equipment to be appropriately delivered to a user who is in motion involving vibration.

### Means for Solving the Problem

A notification device of an aspect of the present invention includes: a detection section which detects occurrence of an event which a user is to be notified of; an estimation section which estimates whether or not the user is vibrating; and a stimulation presentation section which provides a notification to the user by presenting a thermal stimulation in a case where the user is vibrating and presenting a vibratory stimulation in a case where the user is not vibrating when the detection section detects the occurrence of the event.

A notification method of an aspect of the present invention includes: a step of causing a computer to detect occurrence of an event which a user is to be notified of; a step of causing the computer to estimate whether or not the user is vibrating; and a step of causing the computer to provide a notification to the user by presenting a thermal stimulation in a case where the user is vibrating and presenting a vibratory stimulation in a case where the user is not vibrating when the computer detects the occurrence of the event.

### Effects of the Invention

According to the present invention, it is possible to provide the technique which allows the notification from the electronic equipment to be appropriately delivered to the user who is in motion involving vibration.

### BRIEF DESCRIPTION OF DRAWINGS

FIG. 1 is a view for explaining functional blocks of a notification device according to an embodiment of the present invention.

FIG. 2 is a view for explaining a hardware configuration of the notification device according to the embodiment of the present invention.

FIG. 3 is an example of a connection state in the notification device according to the embodiment of the present invention.

FIG. 4 is an example of a flowchart for explaining processing in the notification device according to the embodiment of the present invention.

### DESCRIPTION OF EMBODIMENTS

Hereinbelow, a description will be given of an embodiment of the present invention with reference to the drawings. In the description of the drawings, the same portions are designated by the same reference numerals, and the description thereof will be omitted.

(Notification Device)

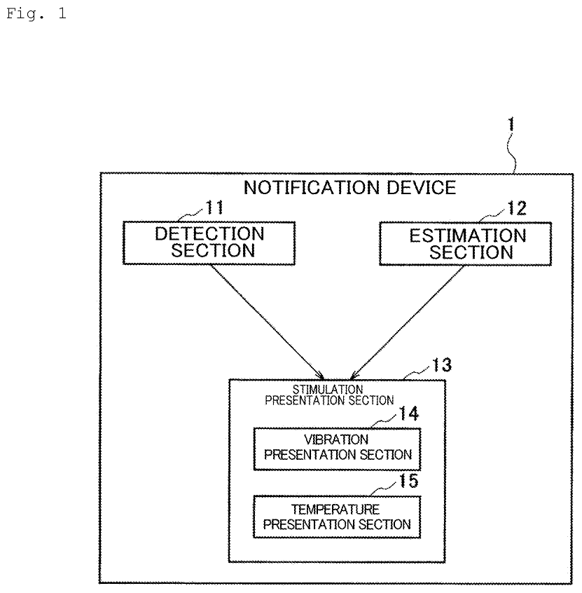

As shown in FIG. 1, a notification device 1 includes a detection section 11, an estimation section 12, and a stimulation presentation section 13. The notification device 1 is mounted on electronic equipment such as a smartphone or a smartwatch. The notification device 1 is equipment having portability which allows a user to wear the equipment directly or indirectly such that the user can feel a thermal stimulation or a vibratory stimulation by the notification device 1.

The detection section 11 detects the occurrence of an event which the user is to be notified of. For example, the event which the user is to be notified of includes an incoming phone call or an incoming mail, arrival of a scheduled time, an alarm of a human body sensor, and the like, and is an event of which notification to the user is determined to be necessary based on data collected or managed by the electronic equipment on which the notification device 1 is mounted. The detection section 11 may detect the occurrence of the event which the user is to be notified of when a notification is provided from the electronic equipment, an external device, a sensor, or the like on which the notification device 1 is mounted.

The estimation section 12 estimates the state of the user, especially whether or not the user is vibrating. That the user is vibrating denotes that the user is performing a movement involving vibration such as walking, running, jumping, or other movements.

The estimation section 12 determines whether or not the user is vibrating by using a value obtained from an acceleration sensor. For example, in the case where the magnitude of a value of each of axes x, y, and z obtained from the acceleration sensor or the magnitude of a norm (√(x2+y\hat{ }2+z\hat{ }2)) exceeds a threshold value, the estimation section 12 determines that the user is vibrating. In addition, the estimation section 12 may estimate whether the user is walking or running according to, e.g., the method described in PTL 1.

When the detection section 11 detects the occurrence of the event, the stimulation presentation section 13 provides a notification to the user by presenting the thermal stimulation in the case where the user is vibrating, and presenting the vibratory stimulation in the case where the user is not vibrating. The stimulation presentation section 13 gives an appropriate stimulation to the user according to whether or not the user is vibrating to thereby notify the user of the occurrence of the event.

The stimulation presentation section 13 includes a vibration presentation section 14 and a temperature presentation section 15.

The vibration presentation section 14 presents the vibratory stimulation to the user. The vibration presentation section 14 controls a device which vibrates such as, e.g., a vibrating motor. When an instruction to present the vibratory stimulation is input from the stimulation presentation section 13, the vibration presentation section 14 vibrates the device which vibrates according to a predetermined pattern to present the vibratory stimulation, and stops the vibration of the vibrating device when the pattern is ended.

The temperature presentation section 15 presents the thermal stimulation to the user. The temperature presentation section 15 controls a device which presents a predetermined temperature of, e.g., a Peltier element. When an instruction to present the thermal stimulation is input from the stimulation presentation section 13, the temperature presentation section 15 sets the temperature of the device which presents temperature to a predetermined temperature, and sets the predetermined temperature thereof back to a default temperature when a predetermined time elapses.

The temperature presentation section 15 may present any thermal stimulation which is a warm stimulation or a cold stimulation. For example, the temperature of the warm stimulation is about 40° C. which is higher than body temperature, and the temperature of the cold stimulation is about 15° C. which is lower than body temperature. In addition, according to details detected by the detection section 11, it may be determined which thermal stimulation is presented.

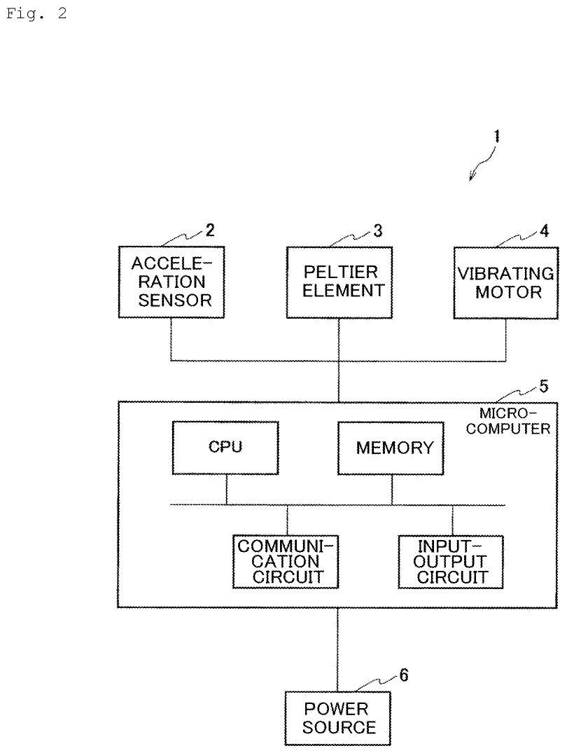

A description will be given of a hardware configuration which shows an implementation example of the notification device 1 with reference to FIG. 2. The notification device 1 includes, as hardware, an acceleration sensor 2, a Peltier element 3, a vibrating motor 4, a microcomputer 5 (micro-controller), and a power source 6.

The Peltier element 3 is controlled by the temperature presentation section 15 in FIG. 1. The Peltier element 3 is one of thermoelectric elements (semiconductor thermoelectric elements) which use the Peltier effect. While the Peltier element 3 is used as an example of the thermoelectric element in the embodiment of the present invention, the thermal stimulation may also be presented by using other thermoelectric elements. In the embodiment of the present invention, the notification device 1 has one or more Peltier elements 3.

The Peltier element 3 includes a PN junction portion of which the temperature changes when a current is applied to the PN junction portion. The Peltier element 3 is provided such that the temperature of the PN junction portion is felt by a person who touches the notification device 1, especially the Peltier element 3. For example, the Peltier element 3 may be provided such that the PN junction portion is exposed on the surface of the notification device 1, or any member such as a ceramic substrate may be provided on the outside of the Peltier element 3. A person receives the thermal stimulation by touching the PN junction portion or a member with which the PN junction is covered.

The microcomputer 5 is a computer including a CPU, a memory, a communication circuit, and an input-output circuit, and functions as the detection section 11, the estimation section 12, and the stimulation presentation section 13 in FIG. 1. The microcomputer 5 is connected to each Peltier element 3 with a lead wire (not shown) or the like. The microcomputer 5 applies a current to the Peltier element 3 and causes the Peltier element 3 to present the thermal stimulation. The microcomputer 5 controls drive of the Peltier element 3.

The microcomputer 5 applies a current to the Peltier element 3, whereby it is possible to change the temperature of the PN junction portion of the Peltier element and present the thermal stimulation in a portion with which the notification device 1 comes in contact. In addition, the microcomputer 5 can select the cold stimulation or the warm stimulation as the thermal stimulation and also control a temperature to be presented (the intensity of the thermal stimulation) by controlling a current value (the direction of a current, the magnitude of a current) applied to the Peltier element 3.

The power source 6 supplies power to the microcomputer 5.

Note that, in the notification device 1, the functions of the detection section 11 and the like may be implemented by reading and executing a predetermined program with the CPU. The program of the notification device 1 can be stored in a computer-readable recording medium such as an HDD, an SSD, a USB (Universal Serial Bus) memory, a CD (Compact Disc), or a DVD (Digital Versatile Disc), and can also be delivered via a network.

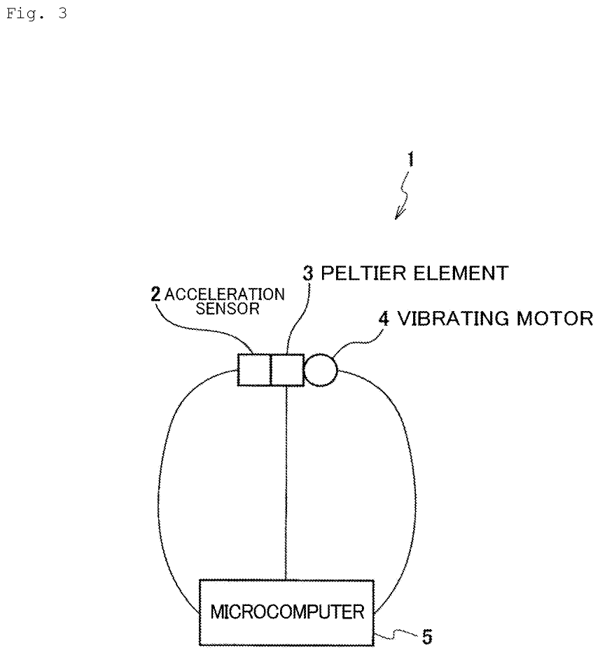

A description will be given of a connection state of the notification device 1 according to the embodiment of the present invention with reference to FIG. 3. Note that the power source 6 is omitted in FIG. 3.

The acceleration sensor 2, the Peltier element 3, and the vibrating motor 4 are connected to the microcomputer 5. The acceleration sensor 2 determines the state of the user, and hence the acceleration sensor 2 is provided at a position which works in response to the movement of the user. The Peltier element 3 and the vibrating motor 4 give the thermal stimulation and the vibratory stimulation to the user, and hence the Peltier element 3 and the vibrating motor 4 are provided at positions close to the skin of the user.

Typically, the acceleration sensor 2, the Peltier element 3, and the vibrating motor 4 are incorporated in electronic equipment such as, e.g., a smartphone or a smartwatch, and the electronic equipment is carried by the user. In addition, as another example, the acceleration sensor 2, the Peltier element 3, and the vibrating motor 4 may also be incorporated in electronic equipment including a transmitter-receiver. In this case, a measurement value of the acceleration sensor 2 is transmitted to an external computer, and the Peltier element 3 gives the thermal stimulation or the vibrating motor gives the vibratory stimulation according to an instruction from the external computer.

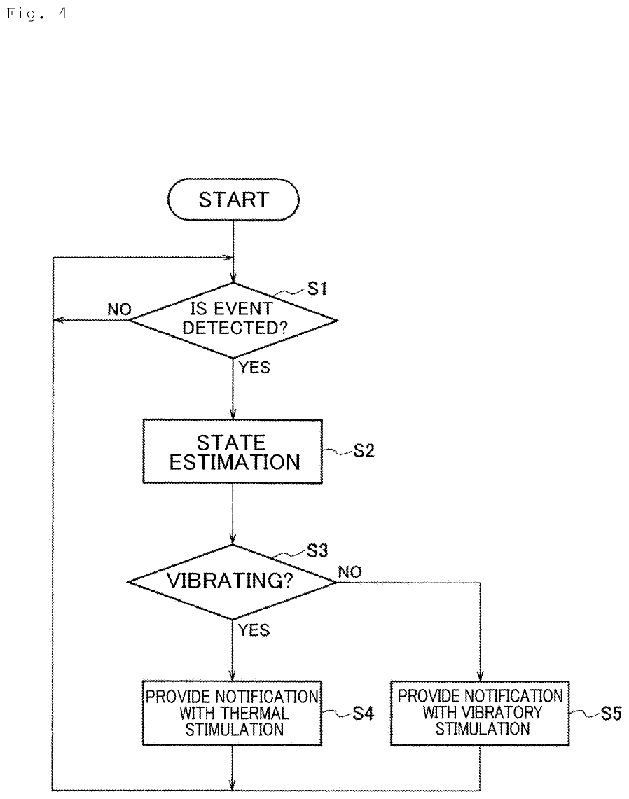

A description will be given of processing of the notification device 1 with reference to FIG. 4.

In Step S1, the detection section 11 waits for an event of which notification is to be provided to the user. When the detection section 11 detects the event, the estimation section 12 estimates the state of the user by using the measurement value obtained from the acceleration sensor 2 in Step S2.

In Step S3, in the case where the state of the user estimated in Step S2 indicates that the user is vibrating, the temperature presentation section 15 controls the Peltier element 3 and provides a notification to the user with the thermal stimulation in Step S4. In the case where the state of the user estimated in Step S2 indicates that the user is not vibrating, the vibration presentation section 14 controls the vibrating motor 4 and provides a notification to the user with the vibratory stimulation in Step S5.

The above-described notification device 1 according to the embodiment of the present invention provides a notification to the user with the thermal stimulation when the user is performing a movement involving vibration such as walking, running, or the like, and hence it is possible to appropriately provide a notification to the user even in a situation in which it is difficult for the user to notice the vibratory stimulation.

Note that the present invention is not limited to the above embodiment, and various modifications may be made without departing from the gist thereof.

### REFERENCE SIGNS LIST

1 Notification device
2 Acceleration sensor
3 Peltier element
4 Vibrating motor
5 Microcomputer
6 Power source
11 Detection section
12 Estimation section
13 Stimulation presentation section
14 Vibration presentation section
15 Temperature presentation section

1. A notification device comprising circuitry that executes instructions that cause performance of operations to:
detect occurrence of an event which a user is to be notified of;
which estimate whether or not the user is vibrating; and
provide a notification to the user by presenting a thermal stimulation in a case where the user is vibrating and presenting a vibratory stimulation in a case where the user is not vibrating when the detection section detects the occurrence of the event.

2. A notification method comprising:
causing a computer to detect occurrence of an event which a user is to be notified of;
causing the computer to estimate whether or not the user is vibrating; and
causing the computer to provide a notification to the user by presenting a thermal stimulation in a case where the user is vibrating and presenting a vibratory stimulation in a case where the user is not vibrating when the computer detects the occurrence of the event.
